(19) United States
(12) Patent Application Publication
(10) Pub. No.: US 2005/0093220 A1
(43) Pub. Date: May 5, 2005

(54) Device for the production of folded products

(75) Inventors: Burkard Otto Herbert, Wurzburg (DE); Stefan Wander, Helmstadt (DE); Patrick Otmar Schmitt, Rittershausen (DE)

Correspondence Address: Douglas R Hanscom;Jones Tullar & Cooper, P O Box 2266, Eads Station, Arlington, VA, 22202, US

(73) Assignee: Koenig & Bauer Aktiengesellschaft, Wurzburg (DE)

(21) Appl. No.: 10/498,507

(22) PCT Filed: Dec. 17, 2002
(86) PCT No.: PCT/DE02/04610

(30) Foreign Application Priority Data
Dec. 21, 2001 (DE) 101 63 209.6

(51) Int. Cl. B41F 13/58

(52) U.S. Cl. 270/5.01

(57) ABSTRACT

A device is used for producing folded products from sheets or partial sheets. The folding device includes a folding assembly that is provided with at least three forming hoppers which are aligned in a staggered and horizontal manner relative to one another, and laterally in the direction of sheet movement. Each of the hoppers has a width of at least two upright newspaper pages or of four printed pages lying in tabloid format. When viewed from a horizontal position, the hoppers at least partially overlap in a vertical direction. At least one of the outer hoppers is hoppers is offset vertically with respect to an inner hopper.

### CROSS-REFERENCE TO RELATED APPLICATIONS

The subject U.S. patent application is the U.S. National Phase of PCT/DE02/04610, filed Dec. 17, 2002; published as WO 03/055776 A1 on Jul. 10, 2003, and claiming priority to DE 101 63 209.6, filed Dec. 21, 2001.

### FIELD OF THE INVENTION

The present invention is directed to a device for making folded products. The folded products are produced in a folder structure which contains a hopper group with three hoppers, or two hopper groups, each with at least two hoppers.

### BACKGROUND OF THE INVENTION

A hopper structure for a double-width printing press is known from DE 32 37 504 A1. A third hopper is arranged next to two hoppers at the same level for increasing production options. The webs, which are laterally turned out of the press, are longitudinally folded on the hopper and can be further processed in one of two folders placed underneath the hopper arrangement.

A hopper structure for a triple-width printing press is known from DE 25 10 057 A1, and which has three upper hoppers and three lower hoppers, each arranged side-by-side. The hoppers of the lower and upper levels are rotated by 180° about their vertical linear axes in such a way that the backs of the folded products are on different sides.

A hopper structure for a triple-width printing press is also known from DE 41 28 797 C2. Six hoppers are arranged on three levels for increasing production.

EP 1 145 850 A1 shows a hopper arrangement of a printing press for printing illustrations wherein, besides a first hopper of a width of four A4 pages, a correspondingly wider, or partially wider, second hopper and a third, partially wider, smaller hopper are arranged. The two hoppers located on the outside of the hopper arrangement, and therefore the folded strands formed by these hoppers, can be displaced in the longitudinal direction of the printing press in order to make possible a displaced deposition of the subsequently transversely cut products.

A split web guidance roller for guiding a double-width web is known from DE 199 59 152 A1. The two roller sections can be driven independently of each other by their own drive motors for the simultaneous production of two different products each having a different number of pages.

DE 42 04 254 C2 shows two hoppers arranged on one level, which two hoppers are arranged to be horizontally movable. A third hopper is arranged on a level above or below these two hoppers and is centered with respect to an incoming whole web.

Folder structures which are arranged above two folders that are placed underneath are disclosed in U.S. Pat. No. 4,725,050. Strands of a lower hopper group can be conducted to one folder, and strands of an upper hopper group can be conducted to the other folder.

### SUMMARY OF THE INVENTION

The object of the present invention is directed to providing a device for making folded products.

In accordance with the present invention, the object is attained by the provision of a device for making folded products which can consist of a folder structure having at least three hoppers in a hopper group, or two hopper groups, each with at least two hoppers. These hoppers can be arranged in different positions with respect to each other to fold longitudinal strands passing through the device. The several hopper groups or hoppers in one of the groups can be arranged at different levels. The hoppers can also be displaced laterally with respect to each other.

The advantages to be attained by the present invention lie, in particular, in that a great amount of flexibility in the products of a printing press is created, without endangering the operational dependability and/or the product quality of the press, and while maintaining a predetermined structural height. The least possible structural space is required without this being accomplished at the cost of the operational dependability and/or product quality of the press.

The arrangement of a third hopper next to two other hoppers makes an increased product variety possible. In particular, in connection with two folders assigned to the three hoppers and/or in connection with an embodiment of two levels of hoppers arranged one above the other, with each level having three hoppers, this arrangement offers the possibility of producing different products in parallel. In connection with double-width printing presses, the arrangement can be one of two folders substantially aligned with the printing press, i.e. with the first two hoppers aligned with the printing press, so that the products running over these two hoppers can be each selectively conducted over the shortest possible distance into one of the two folders, or can be conducted together into one of the folders.

With respect to product variety and efficiency, it is of particular advantage to drive the rollers assigned to the third hopper independently for transporting the partial webs. In a further development, all of the rollers and/or partial rollers, or groups of rollers, are embodied with their own drive motors for this purpose. This is also made possible, without a need for additional structural space, by use of the displaced arrangement.

### BRIEF DESCRIPTION OF THE DRAWINGS

A preferred embodiment of the device for the production of folded products in accordance with the present invention is represented in the drawings and will be described in greater detail in what follows.

Shown are in:

FIG. 1, a schematic front elevation view of a hopper structure in accordance with the present invention, and in

FIG. 2, a side elevation view of a variant of the web transport.

### DESCRIPTION OF THE PREFERRED EMBODIMENT

A printing press, and in particular, a web-fed rotary printing press, has printing groups or printing units, which are not specifically represented, and by the use of which, several webs 01 of material to be imprinted, webs 01 for short, can be imprinted. The printing units are embodied as being “double wide”, for example, which means that the printing cylinders have a length which corresponds to at least four printed pages, for example four newspaper pages in Rhenic, Berlin, New York Times format, etc., or a length which corresponds to eight horizontal pages in tabloid format such as pages of a telephone directory, for example.

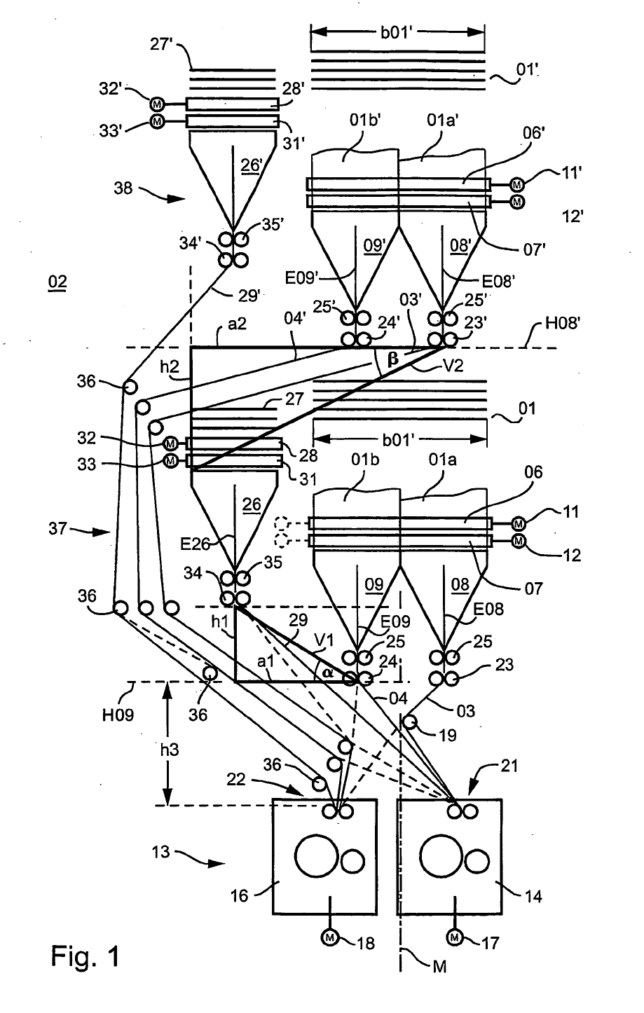

After the double-width webs 01 in the above-described example, i.e. the four printed pages of a width b01 of the web 01, have been imprinted in the printing units, they are conveyed to a hopper structure 02 for further processing. On the way to the hopper structure 02, the webs 01 are cut in the longitudinal direction into partial webs 01a, 01b by a cutting device, which is not specifically represented, and are combined into web a strand 03 or 04, respectively as seen in FIG. 1. Three cutting devices can also be arranged for use with printing in tabloid format, which three cutting devices cut the webs 01 longitudinally into quarters and into a corresponding number of strands 03, 04. In FIG. 1, combining the webs 01 into the strand 03, 04 takes place through the use of a separate combining roller 06, or a group of combining rollers 06, before the strand 03, 04 is afterwards conducted, via a roller 07, embodied for example, as a hopper roller 07, to respective hoppers 08, 09, for example, which are embodied as so-called double hoppers 08, 09. The hoppers 08, 09 are preferably arranged aligned with the respective partial webs 01a, 01b, so that during so-called “straight forward operations” these partial webs 01a, 01b run up on the respective hopper 08, 09 without displacement. In an advantageous embodiment, the combining roller 06 and the hopper roller 07 each have their own drive motors 11, 12, by the operation of which drive motors 11, 12 the web tension can be set or adjusted. In a further development, the roller 06 and/or the roller 07 can be embodied as rollers 06, 07 which are divided over their length, and in which each partial roller element can be driven by its own drive motor 11, 12, with each roller thus having two drive motors 11, 12, as seen in FIG. 1.

A folding unit 13 is arranged downstream of the hopper structure 02 and has two folders 14, 16. In an advantageous embodiment of the present invention, and as schematically represented in FIG. 1, the two folders 14, 16 each have their own drive motors 17, 18. The strands 03, 04 can be fed selectively together to either one of the two folders 14, 16, or each strand 03, 04 can be fed to a separate one of the folders 14, 16. For setting the paths to be travelled by the two strands 03, 04 between the hoppers 08, 09 and the folders 14, 16, at least one deflection roller 19, or roller 19, whose position can be changed, is provided. The at least one deflection roller 19 can be rotatorily driven by its own drive motor, which is not specifically represented, and its position can be changed by the provision of an actuating drive, which also is not specifically represented.

The two folders 14, 16 of the folding unit 13 are advantageously aligned, with respect to each other, and with respect to the two hoppers 08, 09, in such a way that the strands 03, 04 can be fed to the two folders 14, 16 over the shortest possible distance. In an ideal case, the two folders 14, 16 are arranged underneath the hoppers 08, 09 in such a way that the respective inlets into the two folders 14, 16, i.e. folder inlet rollers 21, 22, for example a folder inlet roller group 21, 22, assigned to each respective folder 14, 16, can each lie symmetrically, in relation to a center plane M, between the two hoppers 08, 09. Distances between an inlet into the folder 14, 16 and the hoppers 08, 09, which are respectively arranged “crossed” above them, should not differ by more than 200 mm, and preferably by not more than 100 mm. The center plane M is located parallel to and is centered between two planes which extend through the longitudinally folded strands 03, 04 in the area of rollers 23, 24, for example the traction or transfer rollers 23, 24 assigned to the hoppers 08, 09. As a rule, these planes coincide with planes of symmetry E08, E09 of the hoppers 08, 09, such as is represented in FIG. 1. Additional pairs of rollers 25, for example pairs of folding rollers 25, are typically arranged between the traction or transfer rollers 23, 24 and the hoppers 08.

It is possible, by use of the device for the production of folded products in accordance with the present invention, for example during collecting operations and when utilizing “double-sized” printing cylinders, for example by using a forme cylinder has a circumference corresponding to two upright printed pages and, if necessary, including non-printing parts, such as fastening devices, etc., to produce a product with a maximum of four books. If there is no collection, or if the forme cylinders merely have a single circumference, two books can be produced. The four or two books can be selectively all conducted to one of the two folders 14, 16, or can be split up between both folders 14, 16.

With the provision of a third hopper 26, whose plane of symmetry E26 is arranged transversely, with respect to the running direction of the webs 01, and which is horizontally displaced with respect to the planes of symmetry E08, E09 of the first two hoppers 08, 09, the flexibility of the device, with regard to possible products, is considerably increased. Webs 01, in particular, partial webs 01 which, for example, through the operations of linear cutting and turning via turning bars, which are not specifically represented, have been brought out of the row of the webs 01 directed to hoppers 08, 09, into the row of the third hoppers 26, are, in their running direction, centered with respect to the plane of symmetry E26 of the third hopper 26, are, for example, first combined into a strand 29 by a combining roller 28 of their own, which is different from the combining roller 06, before they are conducted, for example via their own hopper roller 31, which is different from the hopper roller 07, for example a hopper roller 31, to the third hopper 26. In an advantageous embodiment of the invention each of the rollers 28, 31 has its own drive motor 32, 33, by the use of which, the tension of the partial webs 27, or of the strand 29, can be set, or can be regulated individually with respect to the remaining strands 03, 04. In the case of a double-width printing press, the third hopper 26, as well as its assigned rollers 28, 31 and feeding devices, are arranged laterally, with respect to the row of the printing press or its printing units. In this way, the straight production of conventional products is still provided via the two first hoppers 08, 09 which are called, for example, main hoppers, and, for an expanded production, the option of a production via the third hopper 26 called, for example, a side hopper is provided. The tip of the displaced side hopper 26 is arranged in alignment with the tip of the adjacent main hopper 09 in such a way that the strands 04, 29, for example the backs of the respective folded product, come to rest on top of each other after having been brought together. The tips of the hoppers 08, 09, 26 are located in the same plane, which plane is defined by the running direction of the strands 03, 04, 29 when leaving the hopper 08, 09, 26 at its tip and normal to the plane of the folded strand 03, 04, 29. As a rule, this plane extends generally vertically and lies parallel, with respect to the longitudinal direction of the rollers 07 and/or 31.

The third hopper 26 is preferably configured as a hopper 26 that is equivalent to the other hoppers 08, 09, for use with a width of a partial web 27 having two printed pages, for example two upright newspaper pages or, for example, four horizontal pages in tabloid format. This means that there is no difference between the options of the possible partial products, or books, which can be folded longitudinally on the various hoppers 08, 09, 26. Following lower end of hopper 26, rollers 34, for example traction or transfer rollers 34, have also been assigned to it. Here, too, at least a further pair of rollers 35, such as, for example folding rollers 35, are also typically arranged between the traction or transfer rollers 34 and the hopper 26.

The arrangement of the third or side hopper 26 laterally next to the two other main hoppers 08, 09 requires a widening of the hopper structure 02 from, for example, a width b01 of a double-width web 01, plus possible lateral projections because of a frame, drive motors, roller projections, etc., to at least the width of one triple-width web, or of one and a half double-width webs 01. A maximum distance between two strands 03, 04 is now increased by a distance a1 between the strand 04 and the strand 29, as seen in FIG. 1.

The deflection of a strand 03, 04, 29, consisting of several webs 01 or of several partial webs 27, in particular, causes problems with an interference-free guidance of the web or strand because of a possible danger of a break in the web, the possibility of overstressing the web 01, 27, and also because of other traction and/or guidance elements and with the quality of the resultant product. The latter is caused by a wave formation or by creasing of a web 01 or of a partial web 27, which “lies on the inside” during the deflection of the strand 03, 04, 29, as a result of different expansion stress, or of rubbing of the imprinted webs 01 or partial webs 07 against each other. In the first case, this problem can lead to errors in the cutting register of the webs 01, 27 with respect to each other, and, in the last case, can possibly lead to a worsening of the printed image. Although, in the course of repeated direction changes from the hopper 08, 09, 26 to the folder 14, 16, the resulting direction change problem is, as a rule, removed, or is reduced, at least partially by “positive” and “negative” direction changes, taking into consideration the preceding sign, the sum of the amounts or numbers of the individual direction changes is of great importance for considerations of dependability and quality.

Dependable and exact running of the strands 03, 04, 29 while, at the same time, a compact construction, is achieved in the present invention, in that the third hopper 26 is arranged vertically displaced with respect to the second hopper 09. In contrast to the location of a third hopper arranged directly above one of the other two hoppers 08, 09, this positioning results in a considerable saving in the structural height of the device, since it is necessary to provide feeding devices, which are not specifically represented, to the hoppers 08, 09, 26 in the respective structural area on each hopper level next to the hoppers 08, 09, 26.

Although the third hopper 26 increases the maximum distance between two strands 03, 04, 29 by at least the width of the partial web 27, in the arrangement depicted in FIG. 1 there are clearly a reduced number of directional changes required for the strands 03, 04, 29, and in particular for the strand 29, in contrast to the customary or prior art arrangement. Correspondingly, with a constant radius of a roller, for example a deflection roller, or a driven traction roller, reduced web loop angles are possible, in comparison to an arrangement of the hopper 26 on the level of the two other hoppers 08, 09.

A vertical displacement of the third hopper 26, with respect to the two hoppers 08, 09, by a height h1 is preferably of such a size that an angle α between the horizontal line H09 at the height of the last structural component toward the bottom assigned to the hopper 09, for example the last traction or transfer roller 24 toward the bottom of hopper 09, and a connecting line V1 between the corresponding two last structural components toward the bottom of hopper 26, in this case after the last lower rollers 24 and 34, is at least equal to or greater than 15°. In general, the last structural component of a hopper is to be understood as being the structural component which is located farthest toward the bottom of the hopper, and which is fixedly connected with the hopper 08, 09, 26 as a structural group. This can be, for example, the nip of one of several successively arranged pairs of rollers 24, 34, or a lowest point of a deflection roller or of a traction roller connected at a fixed distance, with the exception of adjustment purposes to the hopper 08, 09. Since, as a rule, the hopper 08, 09, 26, with the adjoining rollers 23, 24, 34, constitutes a structural group with fixed distances, except for adjustment purposes, or with a defined limit toward the bottom, with respect to other guide elements, the height h1 of the displacement between hopper 26 and hoppers 08, 09 can also be fixed in accordance with the relative position of a fixed reference point, for example the location of the lower ends of the hoppers 09, 26, i.e. the hopper tips, with respect to each other, which then, at least approximately, corresponds to the height h1 of the displacement of the respectively lowermost structural components.

As previously mentioned, the angle α should be selected to be equal to or greater than 15°, and in particular should be equal to or greater than 25°. In an advantageous embodiment of the present invention the angle α lies between 200 and 60α, in FIG. 1 it is approximately 30°. Therefore, the height h1 for the displacement can be derived from the equation tan α=h1/a1.

An increase in a structural height of the hopper structure 02 having the three side-by-side positioned hoppers 08, 09, 26 with their associated feeding devices, each located above them, can, as a rule, be prevented because fewer feeding devices must be provided for the third hopper 26 than are required to be placed above the two hoppers 08, 09.

The vertical displacement, by the height h1 of the third hopper 26 is of particularly great importance if a further level of hoppers 08′, 09′ is provided above the previously described level of three side-by-side arranged hoppers 08, 09, 26, or, if for other reasons, it is necessary to conduct additional webs 01′, additional partial webs 27′ or additional strands 03′, 04′, 29′ downward and at the side of the printing press via rollers 36, which may be, for example, guide, or deflection and/or traction rollers 36, and which may be provided with or without their own drive mechanisms. For reasons of clarity, only some of these additional rollers 36 have been represented in FIG. 1. As a rule, additional register rollers must be provided, by the use of which additional register rollers the linear register between the strands can be set by deflecting the strands 03′, 04′, 26′.

In this connection, the term “level” is to be understood not as a level in the sense of an arrangement at exactly the same height of the three hoppers 08, 09, 26, or of the two hoppers 08′ and 09′. Instead it identifies hoppers 08, 09, 26, or hoppers 08′ and 09′, whose web feeding devices are respectively located in the same vertical area between two such “levels”, or in the area above the last level. Preferably the hoppers 08, 09, 26, or the hoppers 08′ and 09′ are located next to each other in the horizontal direction in such a way that they at least partly overlap in the vertical direction. If operating levels are assigned to the printing press, the hoppers 08′, 09′ of a level can be arranged on a common operating level, or can be accessible from this level. In this sense, the hopper structure 02 as seen in FIG. 1, has two “levels” of hoppers 08, 09, 26, or hoppers 08′ and 09′. Such an arrangement of side-by-side arranged, overlapping at least in the manner previously mentioned, groups of hoppers 08, 09, 26, or hoppers 08′, 09′ will each be called a hopper group 37, 38, respectively in what follows.

For further increasing the product variety and the product output, as well as for providing further flexibility, the hopper structure 02 has the second hopper group 38 located on a level above the double hopper 08, 09 of the first hopper group 37, and with a further double hopper 08′, 09′ constituted by the two hoppers 08′, 09′. Additional webs 01′, or partial webs 01a′, 01b′, after having been longitudinally cut, are conducted to double hoppers 08′, 09′ in the form of strands 03′, 04′ via combining rollers 06′ and hopper rollers 07′, which are also driven, in an advantageous embodiment, by their own drive motors 11′, 12′. Rollers 23′, 24′, for example traction or deflection rollers 23′, 24′, and folding rollers 25′, are also assigned to these hoppers 08′, 09′ of the second hopper group.

In an advantageous embodiment of the present invention a third hopper 26′ is also laterally arranged next to the double hopper 08′, 09′ of the second hopper group 38, and on which a strand 29′ of partial webs 27′, which, after being combined at a roller 28′, is also conducted over rollers 31′ and passes over folding rollers 35′, as well as over traction or deflection rollers 34′. The arrangement of the second hopper group 38 with the three hoppers 08′, 09′, 26′ above the first hopper group 37 at the top can be embodied in such a way that all three hoppers 08′, 09′, 26′ and their assigned rollers 06′, 28′, or 07′, 31′, 23′, 24′, 34′ are all arranged on one level next to each other. The rollers 06′, 28′, or 07′, 31′, can possibly be embodied as continuous rollers 06′, 28′, or 07′, 31′, if a separate tension regulation is to be omitted.

In an advantageous and cost-effective arrangement, because it is identical, the third hopper 26′ is also displaced vertically in the above described way, as was the situation of the third hopper 26.

Guidance of the upper strands 03′, 04′ 29′ is provided for production, wherein these upper strands can all be guided on one side of the printing press on the outside, past all three lower hoppers 08, 09, 26, and to the folding unit 13. The provision of other web guidance paths, for example between hoppers 08, 09, 26 and/or between strands 03, 04, 29 of the lower hopper group 37, is, of course, possible, but is not represented, for reasons of clarity in the overview shown in FIG. 1.

A production possibly provided by this arrangement, in addition to the customary ones, lies in that one, two or all three strands 03′, 04′, 29′ of the upper hopper group 38 can be selectively guided to their “own” folder 16. This means that, besides the production by the use of the folder 14 from the lower webs 01, 27, it is also possible to either produce a totally different product or, for increasing the printing output, to produce the identical product in parallel streams. Different products can be made completely independently of each other on the upper and on the lower printing groups 37, 38 and/or on the two folders 14, 16. Each one of the two products can have three books, or six books during collection operation. In that case, the webs 01′ for the second product can come from adjoining printing units of a remote section of the printing press. Since the rollers 28, 31, 28′, 31′ of each of the third hoppers 26, 26′, and the rollers 06, 07, 06′, 07′ of the other hoppers 08, 09, 08′, 09′ of the respective first and second hopper groups 37, 38 are driven independently of each other, a selective assignment to the one or to the other product or folder 14, 16, in particular of the strand 29, is possible, in case of different products.

As mentioned above, it is of great importance for the “deflection” of the upper strands 03′, 04′ 29′ to displace the third hopper 26′ vertically upward in the described manner. As can be seen schematically in FIG. 1, it is possible to conduct the strands 03′, 04′, 29′ dependably, and also while preventing losses of quality of the printed product, to the folding unit 13, without it being necessary to increase a height h3 between the inlet into the folders 14, 16, or into their roller groups 21, 22 and the traction or transfer rollers 23, 24, or the respectively lowermost structural components of the hoppers 08, 09. This applies, in particular, if the above mentioned minimum values of the angle α and the advantageous angular ranges of the angle α are to be maintained.

So that a total height of the overall hopper structure 02 is not increased unnecessarily, while at the same time insuring a dependable web run or a dependable guidance of the strands 03′, 04′, 29′, a height h2 between the upper end of the lower third hopper 26 and a horizontal line H08′, at the level of the last lower structural component which is fixedly assigned to the hopper 08′ and which guides the strand 03′, in the depicted example the roller 23′, is not freely selectable. The displacement h1 must be selected, in addition to the requirement for the size of the angle α, in such a way that an angle β between the horizontal H08′ and a connecting line V2 between the lower end of the outside located hopper 08′, or its assigned structural component, and the outer upper limit, or “corner”, of the lower third hopper 26, which is arranged on the other side of the printing press is equal to or less than 15°.

With the production of newspapers in particular, such an angle β, and a height h2, which can be determined by the calculation tan β=h2/a2, must be maintained in order to assure a dependable guidance of the strands 03′, 04′, 29′, which assures a high product quality, and in particular a guidance of the strand 03′, since, as a rule, the latter strand 03′ constitutes the outside of the product which has the product title and which strand 03′ is mostly a thick outer layer. Here, a2 represents the horizontal distance a2 between the level E08′ and the above-mentioned outside located “corner”.

In addition to the deflection and/or the traction rollers represented in FIG. 1, which rollers are not identified in detail, additional, not specifically represented guide rollers, deflection rollers and possibly also other traction rollers can be arranged in the area between the upper hoppers 08′, 09′, 26′ of the second hopper group 38 and the lower hoppers 08, 09, 26, of the first hopper group 37 in the area between, or next to the hoppers 08′, 09′, 26′, or the hoppers 08, 09, 26, as well as in the area between the folding unit 13 and the lower hoppers 08, 09, 26. However, for reasons of clarity, these additional rollers are not specifically represented. Also, the guide rollers, turning bars and the other guidance components, which are required for guiding the webs 01, 01′, or the partial webs 27, 27′, have not been represented also for reasons of clarity.

The displacement of the side hopper 26 or 26′, with respect to the main hoppers 08, 09 or 08′, 09′ respectively by the height h1, in regard to the required structural space and to the compact construction of the printing press, is also advantageous in regards to the arrangement of drive mechanisms, drive motors and possible also to provided gears.

In spite of the provision of the third hopper 26, 26′, it is possible to embody one, or several of the rollers 06, 07, 06′, 07′ as divided rollers, and to drive each of the roller sections by their own drive motors. In FIG. 1, drive mechanisms for not visible, partial rollers above the hoppers 08, 09 are only indicated in dashed lines and by way of example.

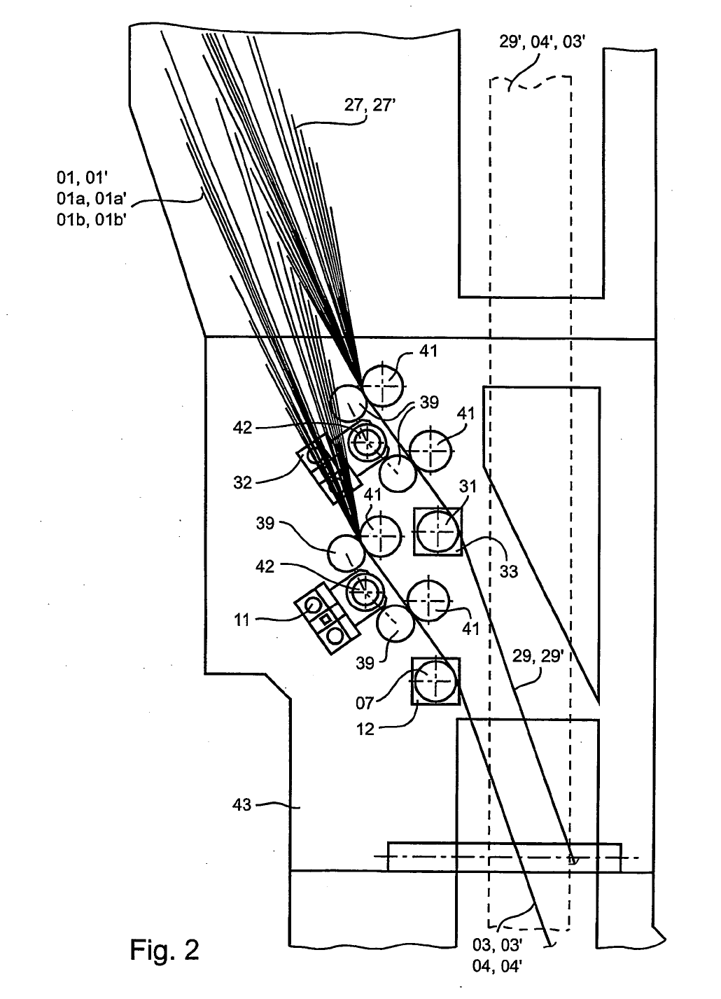

In an advantageous embodiment of the present invention, the combining roller 06, 06′, or 28, 28′ is designed as a combining roller group 06, 06′, 28, 28′ which, as depicted in FIG. 2, has two traction rollers 39 or 39′ and two contact pressure rollers 41 or 41′, or two groups of contact pressure rollers 41 and 41′. This combining roller group 06, 06′, 28, 28′ can be driven by its own drive motors 12, 12′, 33, 33′, wherein the individual traction rollers 06, 06′, 28, 28′ and, in the case of driven contact pressure rollers 41, 41′, the contact pressure rollers 41, 41′, can possibly be driven via a gear 42. Because of the displacement, each of these gears 42 can be arranged on the side of the roller groups 06, 06′, 28, 28′ and pointing into the interior of the printing press, without it being necessary to maintain an additional distance between the respectively second hopper 09, 09′ and the third hopper 26, 26′. The arrangement depicted in FIG. 2 is possible for use with both of the hopper groups 37, 39. For this reason, the appropriate reference symbols have been shown for both of the hopper groups 37, 39 and, in the case where the lower hopper group 37 is meant, a partial web 29′, 04′, 03′, which is visible in this case, has been represented in dashed lines. This arrangement is housed in a frame 43, which is produced from several individual parts.

The above described arrangement of the third hoppers 26, 26′ is, in particular, suitable for use with double-width printing presses, wherein the partial webs 27, 27′ are turned “out of” the row of the printing press, and makes possible the production of additional strands 29, 29′, or books. This applies, in particular, to retrofitting of existing printing presses, wherein the height h3 is already preset and cannot be changed, in the sense of a dependable strand guidance. This arrangement also applies to printing presses to be newly constructed, for which printing presses as low as possible a total height is to be realized because of reasons of exterior constraints or because of the costs connected therewith.

The displaced arrangement of the three hoppers 08, 09, 26, arranged side-by-side can be used, with the above-mentioned advantages, as described, for a hopper structure 02 with only one level or hopper group 37, as well as for hopper structures 02 with two levels, or hopper groups 37, 38, which are arranged on top of each other, as shown in FIG. 1. The spatial assignment of the two outer hoppers 08, 26, with respect to one of the two machine sides, can, of course, also be reversed. In a further development of the present invention, it is also possible to displace the two outside located hoppers 08, 26 upwardly, in relation to the center hopper 09, in the described way. In a still further development, it is also advantageous to employ the described hopper structures 02 in connection with printing units for use in imprinting “triple-width” webs, for example with printing units with three vertical newspaper pages or, for example, with six horizontal pages in tabloid format. The displacement of the two outside located hoppers 08, 26 is, in this case, of great advantage if all three strands 03, 04, 29, or 03′, 04′, 29′ are to be conveyed independently of each other by individually driven rollers 06, 07, 28, 31, 06′, 07′, 28′, 31′, or by individual divided rollers 06, 07, 06′, 07′, each with its own drive motor 11, 12, 11′, 12′ at their respective ends.

While preferred embodiments of a device for the production of folded products, in accordance with the present invention have been set forth fully and completely hereinabove, it will be apparent to one of skill in the art that various changes in, for example, the types of printing presses used, the specific drive motors for the rollers, and the like could be made without departing from the true spirit and scope of the present invention which is accordingly to be limited only by the appended claims.

1-26. (canceled)

27. A device for making folded products including at least one partial web of a web comprising:
a folder structure;
a lower hopper group having at least three lower hoppers including two outside lower hoppers and an inside lower hopper in said folder structure, said at least three lower hoppers being arranged horizontally displaced with respect to each other in said lower hopper group in a direction transverse to a running direction of a web to be folded, each said lower hopper having a width of at least two vertical newspaper pages and at least partially overlapping, viewed in the horizontal direction, in their vertical extension, said at least three lower hoppers each having a lower hopper tip, said three lower hopper tips being arranged on a common level, whereby longitudinal folds formed in partial webs passing through said at least three lower hoppers engaging each other; and
an upper hopper group located above said lower hopper group in said folder structure, said upper hopper group including at least two upper hoppers arranged side by side in a horizontal direction, at least one of said lower outside hoppers being displaced in a vertical direction by a first height from said inside hopper.

28. The device of claim 27 wherein folded partial web strands from said upper hopper groups are all directed to pass beside said lower hopper group.

29. A device for making folded web products from a plurality of partial webs comprising:
a folder structure;
at least first and second hopper groups in said folder structure, each of said first and second hopper groups having at least first and second hoppers which are displaced with respect to each other transversely to a running direction of the web, said at least two hopper groups at least partially overlapping in a horizontal direction, each said hopper being adapted to form a longitudinal folded partial web strand; and
means locating said first hopper group below said second hopper group, said second, upper hopper group having three upper hoppers, strands from said three upper hoppers being conducted on a side around said first, lower hopper group.

30. A device for making folded products from partial webs comprising:
a folder structure;
an upper hopper group and a lower hopper group in said folder structure, each of said upper and lower hopper groups including at least two side by side arranged hoppers, said upper hopper group and said lower hopper group being at least partially overlapping in a vertical direction;
a first folder and a second folder; and
means directing folded partial web strands from said upper hopper group all at one side of said lower hopper group to said second folder.

31. The device fo claim 30 wherein said lower hopper group has three lower hoppers.

32. The device of claim 27 wherein each of said hopper groups has three side-by-side arranged hoppers.

33. The device of claim 29 wherein each of said hopper groups has three side-by-side arranged hoppers.

34. The device of claim 30 wherein each of said hopper groups has three side-by-side arranged hoppers.

35. The device of claim 32 further including means directing three partial web strands from said upper hopper group to a folder on one side of said lower hopper group.

36. The device of claim 33 further including means directing three partial web strands from said upper hopper group to a folder on one side of said lower hopper group.

37. The device of claim 34 further including means directing three partial web strands from said upper hopper group to a folder on one side of said lower hopper group.

38. The device of claim 29 wherein said lower hopper group includes one hopper which is vertically displaced upwardly with respect to remaining hoppers in said lower hopper group.

39. The device of claim 30 wherein said lower hopper group includes one hopper which is vertically displaced upwardly with respect to remaining hoppers in said lower hopper group.

40. The device of claim 27 further including at least one motor driven roller for conveying partial webs assigned to at least two of the hoppers in each of said upper and lower hopper groups which are displaced horizontally from each other.

41. The device of claim 38 further including at least one motor driven roller for conveying partial webs assigned to at least two of the hoppers in each of said upper and lower hopper groups which are displaced horizontally from each other.

42. The device of claim 39 further including at least one motor driven roller for conveying partial webs assigned to at least two of the hoppers in each of said upper and lower hopper groups which are displaced horizontally from each other.

43. A device for making folded products from partial webs comprising:
at least one hopper group having at least first and second hoppers which are arranged horizontally displaced with respect to each other transversely to a running direction of a partial web and which, viewed in a horizontal direction, at least partially overlap in a vertical extension;
at least one roller driven for rotation by a drive motor and adapted to convey a partial web to at least one of said at least first and second hoppers; and
a third hopper in said hopper group, said third hopper being arranged horizontally displaced with respect to said first and second hoppers in said direction transverse to said running direction of a partial web and which, viewed in a horizontal direction, is arranged at least partially overlapping said first and second hoppers.

44. The device of claim 43 wherein one of said hoppers in said hopper group is arranged displaced in a vertical direction from said other hoppers.

45. The device of claim 27 further including a folding unit including first and second folders located underneath said folder structure, each said first and second folders having an inlet arranged symmetrically beneath a center plane between two planes of symmetry of two adjoining hoppers of said hopper group located above each said folder.

46. The device of claim 29 further including a folding unit including first and second folders located underneath said folder structure, each said first and second folders having an inlet arranged symmetrically beneath a center plane between two planes of symmetry of two adjoining hoppers of said hopper group located above each said folder.

47. The device of claim 30 further including a folding unit including first and second folders located underneath said folder structure, each said first and second folders having an inlet arranged symmetrically beneath a center plane between two planes of symmetry of two adjoining hoppers of said hopper group located above each said folder.

48. The device of claim 43 further including a folding unit including first and second folders located underneath said folder structure, each said first and second folders having an inlet arranged symmetrically beneath a center plane between two planes of symmetry of two adjoining hoppers of said hopper group located above each said folder.

49. A device for making folded products including at least one partial web of a web comprising:
a folder structure;
at least a first hopper group in said folder structure, said first hopper group including three hoppers arranged displaced in respect to each other horizontally in a direction transverse to a running direction of the web, one of said three hoppers being vertically displaced with respect to two adjoining other ones of said three hoppers; and
a folding unit located underneath said folder structure, said folding unit includes first and second folders each with a folder inlet, each said folder inlet being arranged symmetrically to a center plane of symmetry defined by said two adjoining hoppers.

50. The device of claim 44 further including a second hopper group having three hoppers horizontally displaced with respect to each other in said running direction of a web, said second hopper group being arranged above said first hopper group.

51. The device of claim 49 further including a second hopper group having three hoppers horizontally displaced with respect to each other in said running direction of a web, said second hopper group being arranged above said first hopper group.

52. The device of claim 27 wherein said vertical displacement is a function of a distance between a first plane of symmetry of said vertically displaced hopper and a second plane of symmetry of said adjoining hoppers of said hopper group.

53. The device of claim 38 wherein said vertical displacement is a function of a distance between a first plane of symmetry of said vertically displaced hopper and a second plane of symmetry of said adjoining hoppers of said hopper group.

54. The device of claim 39 wherein said vertical displacement is a function of a distance between a first plane of symmetry of said vertically displaced hopper and a second plane of symmetry of said adjoining hoppers of said hopper group.

55. The device of claim 44 wherein said vertical displacement is a function of a distance between a first plane of symmetry of said vertically displaced hopper and a second plane of symmetry of said adjoining hoppers of said hopper group.

56. The device of claim 52 wherein said vertical displacement is selected whereby an angle between a reference point between said vertically displacement hopper and the same reference point of said adjoining, not vertically displaced hopper is at least 15°.

57. The device of claim 53 wherein said vertical displacement is selected whereby an angle between a reference point between said vertically displacement hopper and the same reference point of said adjoining, not vertically displaced hopper is at least 15°.

58. The device of claim 54 wherein said vertical displacement is selected whereby an angle between a reference point between said vertically displacement hopper and the same reference point of said adjoining, not vertically displaced hopper is at least 15°.

59. The device of claim 55 wherein said vertical displacement is selected whereby an angle between a reference point between said vertically displacement hopper and the same reference point of said adjoining, not vertically displaced hopper is at least 150.

60. The device of claim 27 wherein a maximum height of said vertical displacement is a function of a distance between an upper outer limit of said vertically displaced hopper and a plane of symmetry of a hopper located on an upper side of said upper hopper group.

61. The device of claim 29 wherein a maximum height of said vertical displacement is a function of a distance between an upper outer limit of said vertically displaced hopper and a plane of symmetry of a hopper located on an upper side of said upper hopper group.

62. The device of claim 38 wherein a maximum height of said vertical displacement is a function of a distance between an upper outer limit of said vertically displaced hopper and a plane of symmetry of a hopper located on an upper side of said upper hopper group.

63. The device of claim 39 wherein a maximum height of said vertical displacement is a function of a distance between an upper outer limit of said vertically displaced hopper and a plane of symmetry of a hopper located on an upper side of said upper hopper group.

64. The device of claim 50 wherein a maximum height of said vertical displacement is a function of a distance between an upper outer limit of said vertically displaced hopper and a plane of symmetry of a hopper located on an upper side of said upper hopper group.

65. The device of claim 51 wherein a maximum height of said vertical displacement is a function of a distance between an upper outer limit of said vertically displaced hopper and a plane of symmetry of a hopper located on an upper side of said upper hopper group.

66. The device of claim 60 wherein said maximum height has a magnitude such that an angle between a horizontal line at a reference point at a level of a bottom reference point of the hopper group and said upper outer limit of said vertically displacement hopper is at least 15°.

67. The device of claim 61 wherein said maximum height has a magnitude such that an angle between a horizontal line at a reference point at a level of a bottom reference point of the hopper group and said upper outer limit of said vertically displacement hopper is at least 15°.

68. The device of claim 62 wherein said maximum height has a magnitude such that an angle between a horizontal line at a reference point at a level of a bottom reference point of the hopper group and said upper outer limit of said vertically displacement hopper is at least 150.

69. The device of claim 63 wherein said maximum height has a magnitude such that an angle between a horizontal line at a reference point at a level of a bottom reference point of the hopper group and said upper outer limit of said vertically displacement hopper is at least 15°.

70. The device of claim 64 wherein said maximum height has a magnitude such that an angle between a horizontal line at a reference point at a level of a bottom reference point of the hopper group and said upper outer limit of said vertically displacement hopper is at least 15°.

71. The device of claim 65 wherein said maximum height has a magnitude such that an angle between a horizontal line at a reference point at a level of a bottom reference point of the hopper group and said upper outer limit of said vertically displacement hopper is at least 15°.

72. The device of claim 56 wherein said reference point is a nip between a last pair of rollers toward a bottom of, and assigned to said hopper.

73. The device of claim 57 wherein said reference point is a nip between a last pair of rollers toward a bottom of, and assigned to said hopper.

74. The device of claim 58 wherein said reference point is a nip between a last pair of rollers toward a bottom of, and assigned to said hopper.

75. The device of claim 59 wherein said reference point is a nip between a last pair of rollers toward a bottom of, and assigned to said hopper.

76. The device of claim 66 wherein said reference point is a nip between a last pair of rollers toward a bottom of, and assigned to said hopper.

77. The device of claim 67 wherein said reference point is a nip between a last pair of rollers toward a bottom of, and assigned to said hopper.

78. The device of claim 68 wherein said reference point is a nip between a last pair of rollers toward a bottom of, and assigned to said hopper.

79. The device of claim 69 wherein said reference point is a nip between a last pair of rollers toward a bottom of, and assigned to said hopper.

80. The device of claim 70 wherein said reference point is a nip between a last pair of rollers toward a bottom of, and assigned to said hopper.

81. The device of claim 71 wherein said reference point is a nip between a last pair of rollers toward a bottom of, and assigned to said hopper.

82. The device of claim 56 wherein said reference point is a nip of said hopper.

83. The device of claim 57 wherein said reference point is a nip of said hopper.

84. The device of claim 58 wherein said reference point is a nip of said hopper.

85. The device of claim 59 wherein said reference point is a nip of said hopper.

86. The device of claim 27 wherein said hoppers which are not displaced are arranged on a level.

87. The device of claim 40 wherein said hoppers which are not displaced are arranged on a level.

88. The device of claim 41 wherein said hoppers which are not displaced are arranged on a level.

89. The device of claim 42 wherein said hoppers which are not displaced are arranged on a level.

90. The device of claim 44 wherein said hoppers which are not displaced are arranged on a level.

91. The device of claim 49 wherein said hoppers which are not displaced are arranged on a level.

92. The device of claim 27 wherein said folder structure is arranged adjoining at least one printing unit of a printing press having a width adapted to imprint webs with selectively four side-by-side arranged vertical newspaper pages and eight side-by-side horizontal pages in tabloid format.

93. The device of claim 29 wherein said folder structure is arranged adjoining at least one printing unit of a printing press having a width adapted to imprint webs with selectively four side-by-side arranged vertical newspaper pages and eight side-by-side horizontal pages in tabloid format.

94. The device of claim 30 wherein said folder structure is arranged adjoining at least one printing unit of a printing press having a width adapted to imprint webs with selectively four side-by-side arranged vertical newspaper pages and eight side-by-side horizontal pages in tabloid format.

95. The device of claim 43 wherein said folder structure is arranged adjoining at least one printing unit of a printing press having a width adapted to imprint webs with selectively four side-by-side arranged vertical newspaper pages and eight side-by-side horizontal pages in tabloid format.

96. The device of claim 49 wherein said folder structure is arranged adjoining at least one printing unit of a printing press having a width adapted to imprint webs with selectively four side-by-side arranged vertical newspaper pages and eight side-by-side horizontal pages in tabloid format.

97. The device of claim 27 further including at least one web-feeding roller associated with said vertically displaced hopper.

98. The device of claim 38 further including at least one web-feeding roller associated with said vertically displaced hopper.

99. The device of claim 39 further including at least one web-feeding roller associated with said vertically displaced hopper.

100. The device of claim 43 further including at least one web-feeding roller associated with said vertically displaced hopper.

101. The device of claim 49 further including at least one web-feeding roller associated with said vertically displaced hopper.

102. The device of claim 27 wherein tips of said displaced hopper and said adjoining hopper are located on a common level constituted by a running direction of the strand leaving the hopper at said tip and a plane normal to the folder strand.

103. The device of claim 38 wherein tips of said displaced hopper and said adjoining hopper are located on a common level constituted by a running direction of the strand leaving the hopper at said tip and a plane normal to the folder strand.

104. The device of claim 39 wherein tips of said displaced hopper and said adjoining hopper are located on a common level constituted by a running direction of the strand leaving the hopper at said tip and a plane normal to the folder strand.

105. The device of claim 43 wherein tips of said displaced hopper and said adjoining hopper are located on a common level constituted by a running direction of the strand leaving the hopper at said tip and a plane normal to the folder strand.

106. The device of claim 49 wherein tips of said displaced hopper and said adjoining hopper are located on a common level constituted by a running direction of the strand leaving the hopper at said tip and a plane normal to the folder strand.
